(19) United States
(12) Patent Application Publication
(10) Pub. No.: US 2020/0318013 A1
(43) Pub. Date: Oct. 8, 2020

(54) METHOD TO IMPROVE TAILINGS FLOWABILITY FOR PIPELINE TRANSPORT

(71) Applicant: Dow Global Technologies LLC, Midland, MI (US)

(72) Inventors: Lizbeth Rostro, Lake Jackson, TX (US); Wu Chen, Lake Jackson, TX (US); Paul A. Gillis, Lake Jackson, TX (US); Michael K. Poindexter, Sugar Land, TX (US); Jason A. Tubbs, West Columbia, TX (US); Cole A. Witham, Pearland, TX (US)

(73) Assignee: Dow Global Technologies LLC, Midland, MI (US)

(21) Appl. No.: 16/753,529

(22) PCT Filed: Oct. 12, 2018
(86) PCT No.: PCT/US2018/055563

§ 371 Date: Apr. 3, 2020

Related U.S. Application Data
(60) Provisional application No. 62/571,816, filed on Oct. 13, 2017.

(51) Int. Cl. C10G 1/04; C10G 33/04; C02F 11/14; C02F 1/56; C08L 71/02

(52) U.S. Cl. CPC C10G 1/045; C10G 33/04; C02F 11/14; C02F 2103/10; C08L 71/02; C10G 2300/208; C02F 1/56

(57) ABSTRACT

The present invention relates to a method for transporting, flocculating, and dewatering an aqueous tailings stream. Said method comprises adding a flocculant composition comprising a poly(ethylene oxide) (co)polymer with the aqueous tailings stream wherein the aqueous tailings stream has 15 wt % or less solids. Said method is particularly useful for the treatment of suspensions of particulate material, especially waste mineral slurries, especially for the treatment of tailings and other waste material resulting from mineral processing, in particular, the processing of oil sands tailings.

### FIELD

The present invention relates to a method to lower the yield stress in a bitumen tailings stream to improve the efficiency of pipeline transport.

### BACKGROUND

While processing oil sands that are surface mined a significant amount of water is used to extract the heavy oil (bitumen) from the sand. From this process an enormous amount of aqueous waste is created. The waste that is created, known as tailings, is comprised of sand, silt, clay, residual bitumen, and water and does not readily consolidate. As such, over one billion cubic meters of tailings have accumulated in northern Alberta, Canada. A prevailing issue for resolving this environmental concern is the inability to efficiently transport the tailings via pipeline from the point of chemical treatment to the point of deposition where the majority of the dewatering process occurs.

Tailings treated with flocculants are transported to settling ponds for dewatering. The transportation of treated tailings across the mine site can cause significant pumping issues, such as high pumping pressures, due to the high yield stress commonly associated with tailings treated with flocculants. Pumping tailings streams with high solids content (greater 30 wt %) as those exiting a thickener or centrifuge can also create problems.

These issues are amplified when the transport distance is hundreds of meters up to kilometers and/or there is an increase in elevation. For example, it is known that pipeline transportation can induce suffice shear which can negate the dewatering performance of conventional chemical treatments.

There is a need for a method to enable the production of low yield stress treated tailings to facilitate improved pumpability without sacrificing the dewatering properties of the treated tailings.

There is a need for a process that maintains excellent dewatering properties for tailings while providing a very low yield stress material needed for transportation.

### BRIEF SUMMARY

Embodiments relate to method of transporting an aqueous tailings composition by way of a conduit, the method comprising: A) forming an aqueous tailings composition comprising the step of adding a flocculant composition comprising a poly(ethylene oxide) (co)polymer composition that includes a poly(ethylene oxide) polymer and/or a copolymer of ethylene oxide to a tailings stream having a solids content equal to or less than 15 weight percent and B) flowing the aqueous tailings composition through the conduit from a first point to a second point along the conduit. The poly(ethylene oxide) (co)polymer composition may be added in an amount from 10 grams to 10,000 grams per ton of solids in the aqueous tailing composition. In one embodiment of the process disclosed herein above, the poly(ethylene oxide) (co)polymer composition comprises a poly(ethylene oxide) homopolymer, a poly(ethylene oxide) copolymer, or mixtures thereof.

In one embodiment of the process disclosed herein above, the poly(ethylene oxide) copolymer is a copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

In one embodiment of the process disclosed herein above, the poly(ethylene oxide) (co)polymer has a molecular weight of equal to or greater than 1,000,000 Da.

### DETAILED DESCRIPTION

The present invention is a treatment method to enable the production of low yield stress treated aqueous tailings composition and in effect greatly facilitate the pumpability issues present in current treatment strategies without sacrificing the dewatering properties of the treated tailings. The innovation is the use of an aqueous tailings stream having equal to or less than 15 weight percent solids to which a flocculant composition that includes a poly(ethylene oxide) (co)polymer composition is added to attain treated aqueous tailings stream with exceptionally low yield stress values (e.g., less than 25.0 Pa, less than 10.0 Pa, less than 5.0, less than 1.5, less than 1.3, less than 1.0, etc.) The poly(ethylene oxide) (co)polymer composition includes a poly(ethylene oxide) polymer and/or copolymer of ethylene oxide.

The low yield stress values may be obtained at multiple points along a conduit for transporting the treated aqueous tailings composition, e.g., at both a first point and a second point in the conduit. The first point and the second point may be spaced apart by a distance from 1 m to 100 km (e.g., 1 m to 50 km, 1 m to 25 km, etc.) The low yield stress values may be realized even as substantial dewatering occurs, such that the solids content increases in treated aqueous tailings composition. This point is worth noting as pipeline transportation can induce suffice shear to negate the ultimate dewatering performance of certain chemical treatments. Also, should pipeline transportation be suspended for a period of time, restarting the operation can be difficult, if not impossible, for a stream having a high yield stress. However, a material having a low yield stress will mitigate problems associated with a restart. The present invention maintains the excellent dewatering property while going through a very low yield stress material needed for transportation.

The method of embodiments comprises the step of treating a tailings stream having a solids content equal to or less than 15 weight percent and with a flocculant composition that includes the poly(ethylene oxide) (co)polymer composition comprising a poly(ethylene oxide) polymer and/or copolymers of ethylene oxide. For example, at the poly(ethylene oxide) (co)polymer composition may be present in a concentration from 10 grams to 10,000 grams per ton of solids in the aqueous tailing stream composition (exclusive of any water that may be used to dilute the poly(ethylene oxide) polymer and/or copolymers of ethylene oxide). The flocculant composition may include and/or consistent essentially of a solvent composition and the poly(ethylene oxide) (co)polymer composition. The solvent composition may include water and/or like material, e.g., such that the poly(ethylene oxide) (co)polymer composition is soluble therewithin. The flocculant composition may include from 0.1 to 20.0 weight percent (e.g., 0.1 to 15.0 weight percent, 0.1 to 10.0 weight percent, 0.1 to 5.0 weight percent, 0.1 to 3.0 weight percent, 0.1 to 2.0 weight percent, 0.1 to 1.0 weight percent, 0.1 to 0.8 weight percent, 0.1 to 0.5 weight percent, etc.) of the poly(ethylene oxide) (co)polymer composition. The use of the a low solids tailings stream enables the yield stress to remain low, e.g., between the first and second points of a conduit, compared to an untreated tailings stream or tailings stream treated with other flocculant chemistries. The yield stress may be low before and/or after dewatering has occurred.

In exemplary embodiments, low yield stress values such as less than 5.0 (e.g., less than 1.5, less than 1.3, less than 1.0, etc.) may be realized even when the solids content of the treated aqueous tailings composition has increased above 15 weight percent over time after treatment (e.g., a period from 5 mins to 70 mins) For example, the low yield stress value may be realized at solids content levels from 25 weight percent to 45 weight percent.

According to exemplary embodiments, a process for transporting an aqueous tailings stream comprising, consisting essentially of, or consisting of introducing into the tailings stream a poly(ethylene oxide) homopolymer, a poly(ethylene oxide) copolymer, or mixtures thereof, herein after collectively referred to as “poly(ethylene oxide) (co)polymer” herewithin. The tailings stream may be derived from or contain, tailings, especially tailings derived from bitumen recovery, thickener underflows, or unthickened plant waste streams, for instance other mineral tailings, slurries, or slimes, including phosphate, diamond, gold slimes, mineral sands, tails from zinc, lead, copper, silver, uranium, nickel, iron ore processing, coal, oil sands or red mud. The material may be solids settled from the final thickener or wash stage of a mineral processing operation. Thus, the material desirably results from a mineral processing operation. The mineral material may be selected from red mud and tailings containing clay, such as oil sands tailings.

As used herein, the term “oil sands tailings” relates to tailings derived from oil sands extraction operations and includes fluid fine tailings (FFT) and/or mature fine tailings (MFT) tailings from ongoing extraction operations (for example, thickener underflow or froth treatment tailings) which may bypass a tailings pond and from tailings ponds.

The oil sands tailings or other mineral suspensions may have a solids content in the range 5 percent to 80 percent by weight. The slurries or suspensions often have a solids content in the range of 10 percent to 70 percent by weight, for instance 25 percent to 40 percent by weight. In the process of the present invention, the tailings stream to be transported has a solids content equal to or less than 15 weight percent. For example, the solids content may be equal to or greater than 1 weight percent. This can be attained by treating tailings streams comprising low solids content of equal to or less than 15 weight percent solids or by diluting tailings stream having greater than 15 weight percent solids with water, for example process water, prior to the step of treating the tailings stream with a flocculant composition comprising a poly(ethylene oxide) polymer and/or copolymer of ethylene oxide.

The average sizes of particles in a typical sample of the fine tailings may be less than 45 microns, for instance 95 percent by weight of material is particles less than 20 microns and/or 75 percent is less than 10 microns. The coarse tailings may be greater than 45 microns, for instance 85 percent is greater than 100 microns but generally less than 10,000 microns. The fine tailings and coarse tailings may be present or combined together in any convenient ratio provided that the material remains pumpable.

The dispersed particulate solids may have a unimodal, bimodal, or multimodal distribution of particle sizes. The distribution will generally have a fine fraction and a coarse fraction, in which the fine fraction peak is substantially less than 44 microns and the coarse (or non-fine) fraction peak is substantially greater than 44 microns.

The flocculant composition of the process comprises, consists essentially of, or consists of a polymeric flocculant selected from a poly(ethylene oxide) homopolymer, a poly(ethylene oxide) copolymer, or mixtures thereof. As would be understand by one skilled in the art, by poly(ethylene oxide) homopolymer it is meant a polymer formed with ethylene oxide as the monomer, though residual amounts (e.g., less than 3 weight percent, less than 1 weight percent, etc., based on a total weight of monomers) of other monomers may be present in the ethylene oxide material used to make the poly(ethylene oxide) homopolymer. By poly(ethylene oxide) copolymer it is meant a polymer formed using two or more monomers, whereas at least one monomer used is the ethylene oxide.

Poly(ethylene)oxide (co)polymers and methods to make said polymers are known, for example, see WO 2013116027. In one embodiment, a zinc catalyst, such as disclosed in U.S. Pat. No. 4,667,013, can be employed to make the poly(ethylene oxide) (co)polymers. In an exemplary embodiment the catalyst used to make the poly(ethylene oxide) (co)polymers is a calcium catalyst such as those disclosed in U.S. Pat. Nos. 2,969,402; 3,037,943; 3,627,702; 4,193,892; and 4,267,309, all of which are incorporated by reference herein in their entirety.

An exemplary zinc catalyst is a zinc alkoxide catalyst as disclosed in U.S. Pat. No. 6,979,722, which is incorporated by reference herein in its entirety.

An alkaline earth metal catalyst is referred to as a “modified alkaline earth hexammine” or a “modified alkaline earth hexammoniate” the technical terms “ammine” and “ammoniate” being synonymous. A modified alkaline earth hexammine useful for producing the poly(ethylene oxide) (co)polymer is prepared by admixing at least one alkaline earth metal, preferably calcium metal, strontium metal, or barium metal, zinc metal, or mixtures thereof, most preferably calcium metal; liquid ammonia; an alkylene oxide, which is optionally substituted by aromatic radicals, and an organic nitrile having at least one acidic hydrogen atom to prepare a slurry of modified alkaline earth hexammine in liquid ammonia; continuously transferring the slurry of modified alkaline earth hexammine in liquid ammonia into a stripper vessel and continuously evaporating ammonia, thereby accumulating the modified catalyst in the stripper vessel; and upon complete transfer of the slurry of modified alkaline earth hexammine into the stripper vessel, aging the modified catalyst to obtain the final polymerization catalyst. In an exemplary embodiment of the alkaline earth metal catalyst described herein above, the alkylene oxide is propylene oxide and the organic nitrile is acetonitrile.

A catalytically active amount of alkaline earth metal catalyst is used in the process to make the poly(ethylene oxide) (co)polymer, for example the catalyst is used in an amount of from 0.0004 to 0.0040 g of alkaline earth metal per gram of epoxide monomers (combined weight of all monomers, e.g., ethylene oxide, substituted ethylene oxide, and silane- or siloxane-functionalized glycidyl ether monomers), 0.0007 to 0.0021 g of alkaline earth metal per gram of epoxide monomers, 0.0010 to 0.0017 g of alkaline earth metal per gram of epoxide monomers, and/or 0.0012 to 0.0015 g of alkaline earth metal per gram of epoxide monomer.

The catalysts may be used in dry or slurry form in a conventional process for polymerizing an epoxide, typically in a suspension polymerization process. The catalyst can be used in a concentration in the range of 0.02 to 10 percent by weight, such as 0.1 to 3 percent by weight, based on the weight of the epoxide monomers feed.

The polymerization reaction can be conducted over a wide temperature range. Polymerization temperatures can be in the range of from −30° C. to 150° C. and depends on various factors, such as the nature of the epoxide monomer(s) employed, the particular catalyst employed, and the concentration of the catalyst. A typical temperature range is from 0° C. to 150° C.

The pressure conditions are not specifically restricted and the pressure is set by the boiling points of the diluent and comonomers used in the polymerization process.

The reaction time will vary depending on the operative temperature, the nature of the comonomer(s) employed, the particular catalyst and the concentration employed, the use of an inert diluent, and other factors. As defined herein copolymer may comprise more than one comonomer, for instance there can be two comonomers, three comonomers, four comonomers, five comonomers, and so on. Suitable comonomers include, but are not limited to, epichlorohydrin, propylene oxide, butylene oxide, styrene oxide, an epoxy functionalized hydrophobic monomer, a glycidyl ether or glycidyl propyl functionalized hydrophobic monomer, a silane-functionalized glycidyl ether or glycidyl propyl monomer, a siloxane-functionalized glycidyl ether or glycidyl propyl monomer, an amine or quaternary amine functionalized glycidyl ether or glycidyl propyl monomer, and a glycidyl ether or glycidyl propyl functionalized fluorinated hydrocarbon containing monomer. Specific comonomers include but are not limited to, 2-ethylhexylglycidyl ether, benzyl glycidyl ether, nonylphenyl glycidyl ether, 1,2-epoxydecane, 1,2-epoxyoctane, 1,2-epoxytetradecane, glycidyl 2,2,3,3,4,4,5,5-octafluoropentyl ether, glycidyl 2,2,3,3-tetrafluoropropyl ether, octylglycidyl ether, decylglycidyl ether, 4-chlorophenyl glycidyl ether, 1-(2,3-epoxypropyl)-2-nitroimidazole, 3-glycidylpropyl triethoxysilane, 3-glycidoxypropyldimethylethoxysilane, diethoxy(3-glycidyloxypropyl)methylsilane, poly(dimethylsiloxane) monoglycidylether terminated, and (3-glycidylpropyl)trimethoxysilane. Polymerization times can be run from minutes to days depending on the conditions used. Preferred times are 1 h to 10 h.

For the poly(ethylene oxide) copolymer, the ethylene oxide may be present in an amount equal to or greater than 2 weight percent, equal to or greater than 5 weight percent, equal to or greater than 10 weight percent, equal to or greater than 25 weight percent, equal to or greater than 40 weight percent, equal to or greater than 50 weight percent, equal to or greater than 70 weight percent, equal to or greater than 75 weight percent, equal to or greater than 80 weight percent, equal to or greater than 90 weight percent, and/or equal to or greater than 95 weight percent, equal to or greater than 97 weight percent, based on the total weight of said copolymer. The ethylene oxide may be present in an amount equal to or less than 98 weight percent, equal to or less than 95 weight percent, and/or equal to or less than 90 weight percent based on the total weight of said copolymer.

For the poly(ethylene oxide) copolymer, the one or more comonomer may be present in an amount equal to or greater than 2 weight percent, equal to or greater than 5 weight percent, and/or equal to or greater than 10 weight percent based on the total weight of said copolymer. The one or more comonomer may be present in an amount equal to or less than 98 weight percent, equal to or less than 95 weight percent, and/or equal to or less than 90 weight percent based on the total weight of said copolymer. If two or more comonomers are used, the combined weight percent of the two or more comonomers is from 2 to 98 weight percent based on the total weight of said poly(ethylene oxide) copolymer.

The copolymerization reaction may take place in the liquid phase. Typically, the polymerization reaction is conducted under an inert atmosphere, e.g., nitrogen. It is also highly desirable to affect the polymerization process under substantially anhydrous conditions. Impurities such as water, aldehyde, carbon dioxide, and oxygen which may be present in the epoxide feed and/or reaction equipment should be avoided. The poly(ethylene oxide) copolymers can be prepared via the bulk polymerization, suspension polymerization, or the solution polymerization route, suspension polymerization being preferred.

The copolymerization reaction can be carried out in the presence of an inert organic diluent such as, for example, aromatic hydrocarbons, benzene, toluene, xylene, ethylbenzene, and chlorobenzene; various oxygenated organic compounds such as anisole, the dimethyl and diethyl ethers of ethylene glycol, of propylene glycol, and of diethylene glycol; normally-liquid saturated hydrocarbons including the open chain, cyclic, and alkyl-substituted cyclic saturated hydrocarbons such as pentane (e.g. isopentane), hexane, heptane, various normally-liquid petroleum hydrocarbon fractions, cyclohexane, the alkylcyclohexanes, and decahydronaphthalene.

Unreacted monomeric reagent oftentimes can be recovered from the reaction product by conventional techniques such as by heating said reaction product under reduced pressure. In one embodiment of the process, the poly(ethylene oxide) (co)polymer product can be recovered from the reaction product by washing said reaction product with an inert, normally-liquid organic diluent, and subsequently drying same under reduced pressure at slightly elevated temperatures.

In another embodiment, the reaction product is dissolved in a first inert organic solvent, followed by the addition of a second inert organic solvent which is miscible with the first solvent, but which is a non-solvent for the poly(ethylene oxide) (co)polymer product, thus precipitating the copolymer product. Recovery of the precipitated copolymer can be effected by filtration, decantation, etc., followed by drying same as indicated previously. Poly(ethylene oxide) (co)polymers will have different particle size distributions depending on the processing conditions. The poly(ethylene oxide) (co)polymer can be recovered from the reaction product by filtration, decantation, etc., followed by drying said granular poly(ethylene oxide) copolymer under reduced pressure at slightly elevated temperatures, e.g., 30° C. to 40° C. If desired, the granular poly(ethylene oxide) (co)polymer, prior to the drying step, can be washed with an inert, normally-liquid organic diluent in which the granular polymer is insoluble, e.g., pentane, hexane, heptane, cyclohexane, and then dried as illustrated above.

Unlike the granular poly(ethylene oxide) (co)polymer which results from the suspension polymerization route as illustrated herein above, a bulk or solution copolymerization of ethylene oxide with one or more comonomer yields a non-granular resinous poly(ethylene oxide) (co)polymer which is substantially an entire polymeric mass or an agglomerated polymeric mass or it is dissolved in the inert, organic diluent. It is understood, of course, that the term “bulk polymerization” refers to polymerization in the absence of an inert, normally-liquid organic diluent, and the term “solution polymerization” refers to polymerization in the presence of an inert, normally-liquid organic diluent in which the monomer employed and the polymer produced are soluble.

The individual components of the polymerization reaction, i.e., the epoxide monomers, the catalyst, and the diluent, if used, may be added to the polymerization system in any practicable sequence as the order of introduction is not crucial for the present invention.

The use of the alkaline earth metal catalyst described herein above in the polymerization of epoxide monomers allows for the preparation of exceptionally high molecular weight polymers. Without being bound by theory it is believed that the unique capability of the alkaline earth metal catalyst to produce longer polymer chains than are otherwise obtained in the same polymerization system using the same raw materials with a non-alkaline earth metal catalyst is due to the combination of higher reactive site density (which is considered activity) and the ability to internally bind catalyst poisons.

Suitable poly(ethylene oxide) homopolymers and poly(ethylene oxide) copolymers useful in the method of the present invention may have a weight average molecular weight equal to or greater than 100,000 daltons (Da) and equal to or less than 15,000,000 Da, equal to or greater than 1,000,000 Da and equal to or less than 10,000,000 Da, equal to or greater than 5,000,000 Da and equal to or less than 10,000,000 Da, equal to or greater than 6,000,000 Da and equal to or less than 9,000,000 Da, and/or equal to or greater than 7,500,000 Da and equal to or less than 8,500,000 Da.

Poly(ethylene oxide) (co)polymers are particularly suitable for use in the method of the present invention as flocculation agents for suspensions of particulate material, especially waste mineral slurries. Poly(ethylene oxide) (co)polymers are particularly suitable for the method of the present invention to treat tailings and other waste material resulting from mineral processing, in particular, processing of oil sands tailings.

Suitable amounts of the poly(ethylene oxide) (co)polymer to be added to the aqueous tailings stream range from 10 grams to 10,000 grams per ton of mineral solids in the aqueous tailings stream (g/ton may be referred to as parts per million, ppm). Generally the appropriate dose can vary according to the particular material and material solids content. The amount of the poly(ethylene oxide) (co)polymer is added may be in an amount equal to or greater than 10 g/ton of mineral solids, in an amount equal to or greater than 30 g/ton of mineral solids, in an amount equal to or greater than 70 g/ton of mineral solids, in an amount equal to or greater than 100 g/ton of mineral solids, and/or in an amount equal to or greater than 150 g/ton of mineral solids. The amount of the poly(ethylene oxide) (co)polymer is added may be in an amount equal to or less than 10,000 g/ton of mineral solids, in an amount equal to or less than 7,500 g/ton of mineral solids, in an amount equal to or less than 5,000 g/ton of mineral solids, in an amount equal to or less than 2,500 g/ton of mineral solids, in an amount equal to or less than 1,000 g/ton of mineral solids, and/or in an amount equal to or greater than 500 g/ton of mineral solids. For example, the amount of the poly(ethylene oxide) (co)polymer added may be from 550 g/ton to 1100 g/ton of mineral solids in the aqueous tailings stream.

The poly(ethylene oxide) (co)polymer may be added to the suspension of particulate mineral material, e.g., the tailings slurry, in solid particulate form, an aqueous solution that has been prepared by dissolving the poly(ethylene oxide) (co)polymer into water, or an aqueous-based medium, or a suspended slurry in a solvent.

In one embodiment of the process of the present invention, only the poly(ethylene oxide) (co)polymer is added to the tailings stream, in other words, no other type of flocculant (e.g., polyacrylates, polymethacrylates, polyacrylamides, partially-hydrolyzed polyacrylamides, cationic derivatives of polyacrylamides, polydiallyldimethylammonium chloride (pDADMAC), copolymers of DADMAC, cellulosic materials, chitosan, sulfonated polystyrene, linear and branched polyethyleneimines, polyvinylamines, etc.) or other type of additive typical for flocculant compositions is added.

In one embodiment of the process of the present invention, other additives that are not flocculants may be added to the tailings stream. For example, one or more coagulant, such as salts of calcium (e.g., gypsum, calcium oxide, and calcium hydroxide), aluminum (e.g., aluminum chloride, sodium aluminate, and aluminum sulfate), iron (e.g., ferric sulfate, ferrous sulfate, ferric chloride, and ferric chloride sulfate), magnesium (e.g., magnesium carbonate,) other multi-valent cations and pre-hydrolyzed inorganic coagulants, may also be used in conjunction with the poly(ethylene oxide) (co)polymer.

In one embodiment, the present invention relates to a process for transporting oil sands tailings for dewatering. As used herein, the term “oil sands tailings” relates to tailings derived from oil sands extraction operations and include fluid fine tailings (FFT) and/or mature fine tailings (MFT) tailings from ongoing extraction operations (for example, thickener underflow or froth treatment tailings) which may bypass a tailings pond and from tailings ponds. The oil sands tailings will generally have a solids content of 10 to 70 weight percent, or more generally from 25 to 40 weight percent, and need to be diluted to equal to or less than 15 weight percent with water for use in the present process.

Preferably, the flocs which result from the process of the present invention have an average size between 10 to 50 microns. Preferably, the average floc size is equal to or greater than 1 micron, more preferably equal to or greater than 5 microns, more preferably equal to or greater than 10 microns, more preferably equal to or greater than 15 microns, even more preferably equal to or greater than 25 microns. Preferably, the average floc size is equal to or less than 1000 microns, more preferably equal to or less than 500 microns, more preferably equal to or less than 250 microns, more preferably equal to or less than 100 microns, even more preferably equal to or less than 75 microns. A convenient way to measure floc size is from microscopic photos.

One embodiment of the present invention is a method of transporting an aqueous tailings stream by way of a conduit or pipeline, the method comprising forming a mixture of a tailings stream and a flocculant composition comprising a poly(ethylene oxide) polymer and/or a copolymer of ethylene oxide, in a concentration from 10 grams to 10,000 grams per ton of solids in the aqueous tailing stream and flowing, preferably pumping, the aqueous tailings stream through the conduit from a first point to a second point along the conduit.

In one embodiment of the method of the present invention, there is provided a system for treating the aqueous tailings stream, comprising: a feed pipeline assembly for providing an in-line flow of the tailings stream; a pump for pumping the in-line flow of the tailings stream; an in-line addition assembly in fluid communication with the feed pipeline assembly for adding a flocculant composition comprising a poly(ethylene oxide) polymer and/or a copolymer of ethylene oxide into the in-line flow of the tailings stream to produce an in-line flow of treated tailings material; wherein the treated tailings stream is pumped to a water release zone wherein water separates from the treated tailings material.

In one embodiment there is a dewatering unit in fluid communication with the pipeline assembly for receiving and dewatering the treated tailings material.

In one embodiment of the method of the present invention, the step of dispersing the flocculant composition comprising a poly(ethylene oxide) polymer and/or a copolymer of ethylene oxide into the tailings stream is performed in-line, with or without the use of a static and/or dynamic mixing device.

In another embodiment of the method of the present invention, the step of dispersing the flocculant composition comprising a poly(ethylene oxide) polymer and/or a copolymer of ethylene oxide into the tailings stream is performed in a device other than the pipeline and such device may be interconnected by pipes to transfer the treated tailings stream to the pipeline for further transport.

In another embodiment of the method of the present invention, there is provided a method of treating an aqueous tailings stream, comprising: providing a tailings stream flow in an upstream pipeline section; contacting the tailings stream flow with a flocculant composition comprising a poly(ethylene oxide) polymer and/or a copolymer of ethylene oxide to produce a treated tailings stream in a dispersion pipeline zone; transporting the treated tailings stream through a downstream pipeline section; and dewatering the treated tailings stream.

In one embodiment of the method of the present invention, the pump is configured to operate at a substantially constant flow rate.

In one embodiment of the method of the present invention, the pump is configured to operate at substantially constant rotations per minute.

In one embodiment of the method of the present invention, the in-line addition assembly comprises an injector for adding a solution comprising the flocculant composition into the in-line flow of the tailings stream.

In one embodiment of the method of the present invention, the system also includes a flocculant composition addition controller for controlling the addition of the flocculant composition into the in-line flow of the tailings stream.

In one embodiment of the method of the present invention, the flocculant composition addition controller is configured to provide ratio control of the flocculant composition with respect to the in-line flow of the tailings stream.

In one embodiment of the method of the present invention, the flocculated material has a laminar flow regime.

In one embodiment of the method of the present invention, the flocculated material has a turbulent flow regime.

In one embodiment of the method of the present invention, the flocculated material has at least one laminar flow regime and at least one turbulent flow regime with a transitional regime in between.

In one embodiment of the method of the present invention, the dewatering comprises depositing the treated tailings material onto a sub-aerial deposition site.

In one embodiment of the method of the present invention, the dewatering comprises depositing the treated tailings material in a deep ditch or pit.

In one embodiment of the method the present invention, the dewatering comprises depositing the treated tailings material in a sub-aqueous deposit.

In one embodiment of the method of the present invention, the dewatering comprises subjecting the treated tailings material for thickening, centrifuging and/or filtering.

In one embodiment of the method of the present invention, the tailings stream is comprised of diluted mature fine tailings (MFT).

In one embodiment of the method of the present invention, the tailings stream comprises tailings derived from an oil sands extraction operation.

In one embodiment of the method of the present invention, the tailings stream is retrieved from a tailings pond.

### EXAMPLES

A mature fine tailings (MFT) stream from northern Alberta, Canada comprising 30.4 weight percent solids is diluted to 15 weight percent solids using process water.

The examples below are prepared using 500 gram samples of the diluted MFT. In particular, the diluted tailings stream is mixed with varying doses of a flocculant solution in a graduated cylinder by inverting the covered graduated cylinder upside down repeatedly. Immediately after mixing, dewatering ensued (i.e., the separation of water from the solids to form a water layer) and a high solids layer quickly formed. The tailings samples are allowed to settle for 10 minutes and 1 hour and the yield stress of the resulting high solids layer are evaluated after removing the water layer.

In Example 1, the flocculant added to the diluted tailings stream is a 0.4 wt % aqueous solution including a water soluable poly(ethylene oxide) polymer having an approximate average molecular weight based on rheological measurements of 8,000,000 Da available as POLYOX™ WSR 308 (from The Dow Chemical Company).

In Comparative Example A, no flocculant is added to the diluted tailings stream.

In Comparative Example B, the flocculent added to the diluted tailings stream is partially hydrolyzed polyacrylamide (HPAM) available as ZETAG™ from BASF.

Yield stress measurements are conducted on a Brookfield DVT-3 Rheometer with a V-73 spindle. Solids content is determined by measuring the mud line height within a vessel after a specific time period and then calculating percent solids and total masses below the mud line based on an overall material balance. The results are summarized in Table 1.

TABLE 1

| | Time, | Dose, | Yield Stress, | Solids Content, |
|---|---|---|---|---|
| | min | ppm | Pa | wt % |
| Com Ex A | — | 0 | 0.1 | 7 |
| Com Ex A | — | 0 | 1.3 | 30.4 |
| Ex 1 | 10 | 600 | 0.2 | 34 |
| Ex 1 | 60 | 600 | 0.5 | 44 |
| Ex 1 | 10 | 750 | 0.2 | 30 |
| Ex 1 | 60 | 750 | 0.5 | 41 |
| Ex 1 | 10 | 1000 | 0.1 | 26 |
| Ex 1 | 60 | 1000 | 0.4 | 32 |
| Com Ex B | 10 | 1000 | 6.1 | 6.5 |
| Com Ex B | 60 | 1000 | 25 | 7 |

Referring to Table 1, it is seen for Examples 1 (at varying dose levels) even with substantial dewatering of the stream over a period of 10 mins to 60 mins, low yield stress is still realized. For Comparative Example C (no flocculant) and Comparative Example D (WSR 308 is flocculant) the same procedure as above for Comparative Examples A and B and Example 1 is followed with the exception that the mature fine tailings (MFT) stream from northern Alberta, Canada comprising 30.4 weight percent solids is not diluted. In Comparative Example D, the flocculant is mixed with the tailings using a dynamic mixer. The yield stress and solids content for Comparative Examples C and D are shown in Table 2.

TABLE 2

| | Dose, | Yield Stress, | Solids Content, |
|---|---|---|---|
| | ppm | Pa | wt % |
| Com Ex C | 0 | 1.3 | 30.4 |
| Com Ex D | 350 | 8.2 | 29.7 |

1. A method of transporting an aqueous tailings composition by way of a conduit, the method comprising:
A forming an aqueous tailings composition comprising the step of adding a flocculant composition comprising a poly(ethylene oxide) (co)polymer composition that includes a poly(ethylene oxide) polymer and/or a copolymer of ethylene oxide to a tailings stream having a solids content equal to or less than 15 weight percent; and
B flowing the aqueous tailings composition through the conduit from a first point to a second point along the conduit.

2. The method of claim 1, wherein the poly(ethylene oxide) (co)polymer composition is added in an amount from 10 grams to 10,000 grams per ton of solids in the aqueous tailing composition.

3. The method of claim 1, wherein the poly(ethylene oxide) (co)polymer composition includes a poly(ethylene oxide) homopolymer, a poly(ethylene oxide) copolymer, or mixtures thereof.

4. The method of claim 1, wherein the copolymer of ethylene oxide is present and is a copolymer of ethylene oxide with one or more of epichlorohydrin, propylene oxide, butylene oxide, styrene oxide, an epoxy functionalized hydrophobic monomer, a glycidyl ether functionalized hydrophobic monomer, a silane-functionalized glycidyl ether monomer, or a siloxane-functionalized glycidyl ether monomer.

5. The method of claim 1, wherein the poly(ethylene oxide) (co)polymer has a molecular weight of equal to or greater than 1,000,000 Da.

6. The method of claim 1, wherein the yield stress aqueous tailings composition is less than 5 Pa at the first point and at the second point.

7. The method of claim 1, wherein a distance between the first point and the second point is from 1 m to 100 km.
